(19) United States
(12) Patent Application Publication
(10) Pub. No.: US 2006/0290516 A1
(43) Pub. Date: Dec. 28, 2006

(54) Distress signaling system, a body area network for anabling a distress signaling, method for signaling a condition of a distress and a vehicle arranged witha distress signaling system

(75) Inventors: Jens Muehlsteff, Aachen (DE); Harald Reiter, Aachen (DE); Andras Montvay, Stuttgart (DE); Josef Lauter, Geilenkirchen (DE); Olaf Such, Aachen (DE); Ralf Schmidt, Aachen (DE); Michael Perkuhn, Aachen (DE); Fabian Kohler, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/555,844

(22) PCT Filed: Apr. 29, 2004
(86) PCT No.: PCT/IB04/01488

§ 371 Date: Nov. 3, 2005

(30) Foreign Application Priority Data
May 8, 2003 (EP) 03101270.1

(51) Int. Cl. G08B 23/00

(52) U.S. Cl. 340/573.1

(57) ABSTRACT

The invention relates to a distress signaling system, a body area network for enabling a distress signaling, a method for signaling a condition of a distress and a vehicle arranged with the distress signaling system. The distress signaling system 10 according to the invention comprises monitoring means 11 arranged in a vehicle in order to monitor a vital sign of a seated passenger by means of a sensor 12 arranged to measure a signal representative to said sign. The monitoring means 11 are preferably arranged to perform a continuous monitoring of the vital sign of the passenger and are further arranged to provide a corresponding signal to the front-end electronics 20 of the system 10. The front-end electronics 20 is arranged to analyze the signal from the monitoring means 11. For that purpose the front-end electronics 20 comprises a data processing means 21 arranged to process the measured signal in order to yield data representative to a condition of the passenger. The data processing means 21 comprises a preamplifier 22, an analogue processing circuit 22 and an ADC unit 23. The data processing means 21 forwards the corresponding data to the data analysis means 25, arranged to analyze said data in order to yield a condition-related parameter. The determined condition-related parameter is written into a first look-up table 25a. The data analysis means 25 is further arranged to compare said condition-related parameter to a preset valid parameter stored in a second look-up table 25b. In case the data analysis means detects that the condition-related parameter exceeds a preset valid parameter, it generates a trigger signal to actuate the indicating means 26. The indicating means 26 receives the trigger signal and generate a suitable feedback to the passenger, preferably by means of a suitable user-interface 27. Additionally, the indicating means 26 can be arranged to control a vehicle control system 29, in order to alter a cabin environment, or to actuate an alarming means of the vehicle, like an acoustic alarm and/or the emergency lights and/or to actuate an engine of the vehicle.

The invention relates to a distress signaling system for a seated passenger in a vehicle.

The invention further relates to a body area network arranged to enable a distress signaling for a seated passenger in a vehicle.

The invention still further relates to a method for signaling a condition of a distress of a seated passenger in a vehicle.

The invention still further relates to a vehicle comprising a distress signaling system.

A signaling system for a seated passenger in a vehicle is known from U.S. Pat. No. 5,990,795. The known signaling system is arranged to provide means of awakening a sleeping or unconscious operator of the vehicle by sounding an alarm with a recorded message within the cabin of the vehicle. For that purpose the known signaling system comprises monitoring means comprising a capacitance element arranged in a shoulder belt of a fastening system of a vehicle seat. The capacitance element is arranged to monitor a value of the capacitance, it being changed upon an event the operator of the vehicle falls into a sleep, which is usually followed by a nodding of the operator's head.

It is a disadvantage of the known signaling system that it provides means for monitoring a single manifestation of an abnormal operator's condition. The known system is not suitable for detecting a condition of a distress of the operator, for example a health-related abnormality or a condition of an anxiety, which can also potentially be harmful to the passenger. The known system also cannot detect a condition of a sleep or unconsciousness, when the head of the operator is not touching his chest.

It is an object of the invention to provide a signaling system which is capable of detecting different kinds of a passenger's distress conditions, ranging from a condition of an anxiety to a condition of a medical emergency, while the passenger is being seated in the vehicle.

A distress signaling system according to the invention comprises:
monitoring means arranged in said vehicle to monitor a vital sign of the seated passenger by means of a sensor arranged to measure a signal representative of said sign;
data processing means arranged to process the measured signal in order to yield data representative to a condition of said passenger;
analysis means arranged to analyze said data in order to yield a condition-related parameter, said analysis means being further arranged to compare said condition-related parameter to a preset valid parameter and to generate a trigger signal upon an event said condition-related parameter exceeds said preset valid parameter;
indicating means actuatable by the trigger signal, said indicating means being arranged to generate a feedback to said passenger.

The technical measure of the invention is based on the insight that a condition of a distress is accompanied by a change in at least one vital sign of a person in question. Therefore, by monitoring a suitable vital sign and by carrying out a suitable analysis thereof, a reliable and versatile distress signaling system is obtained. It must be understood that under the definitions of the current invention, the term passenger is applicable to the operator of the vehicle and to any other seated person in the vehicle.

Preferably, the monitoring means is arranged in a direct vicinity of a seat of the vehicle or is integrated in the seat and/or a belt-fastening system. The monitoring means in the system according to the invention comprise a sensor arranged to monitor a vital sign by means of measuring a suitable signal. Preferably, a cardiac activity by means of measuring an ECG-signal and/or a respiration rate by means of acquiring a plethysmogram are being monitored. The sensor is further arranged to male available the measured signal to the data processing means, which is arranged to process the measured signal in order to yield data representative to a condition of the passenger. For example, in case the cardiac activity of the passenger is monitored, the data processing means analyze an output signal from the sensor and deduce corresponding ECG spectra. The resulting ECG spectra are then forwarded by the data processing means to the data analysis means, which is arranged to analyze the spectra to yield a condition-related parameter. Examples of a suitable condition-related parameter are a heart-rate, a value of an amplitude of a selected peak in the ECG spectrum, or any other suitable characteristic deduced from the ECG spectrum. The analysis means is further arranged to compare the condition-related parameter to a preset valid parameter. An example of a suitable preset valid parameter is a threshold value of a heart-rate. It is also possible to prescribe a plurality of valid parameters, corresponding to a plurality of conditions of the passenger. For example, the system according to the invention can comprise suitable storage means, for example a memory unit, where a plurality of valid parameters are being stored for comparison purposes. Said plurality of valid parameters can comprise a first value of the valid parameter, corresponding to a first condition of the passenger, for example a condition of being asleep. Further, said plurality of valid parameters can comprise a second value of the valid parameter, corresponding to a second condition of the passenger, for example a condition of an anxiety. Still further, said plurality of valid parameters can comprise a third value of the valid parameter, corresponding to a third condition of the passenger, for example a condition of a non-life threatening medical abnormality. Still further, said plurality of valid parameters can comprise a forth value of the valid parameter, corresponding to a forth condition of the passenger, for example a condition of a medical emergency.

The analysis means of the system according to the invention is further arranged to compare the yielded condition-related parameter to the preset valid parameter. In case the yielded condition-related parameter exceeds the preset parameter, a trigger signal actuating the indicating means is generated. The indicating means is arranged to generate a feedback to the passenger upon a receipt of the trigger signal. An example of a suitable feedback is a replay of a prerecorded message, like a verbal message or an instruction or a musical melody. It is also possible that a feedback comprises a buzz-tone. Alternatively, the feedback can comprise an actuation of a cabin light of the vehicle or a suitable actuation of a seat under the passenger in question. Preferably, in case the passenger in question is a driver of the car, the seat is brought into a slightly vibrating state.

It is found to be advantageous that the indicating means is further arranged to control a climate control means of the vehicle upon a receipt of a trigger signal. In a situation when the seated passenger is experiencing a state of anxiety, it can be favorable to create a more pleasant environment, by correspondingly varying a cabin temperature of the vehicle, for example. In case it is detected that the seated passenger is suffering from a condition of a medical emergency, the indicating means is preferably arranged to actuate an alarming means of the vehicle upon a receipt of the trigger signal. In such case, for example, the external lights and/or an acoustic alarming means, for example, a horn of the vehicle can be actuated in order to attract an attention of possible bystanders. This feature is of particular advantage in case the seated passenger is a driver. This action is preferably followed by a controlling of the engine of the vehicle, for example by means of an actuation of a cruise control or any other suitable means.

In an embodiment of the system according to the invention, the sensor comprises magnetic means arranged as a resonant circuit, said magnetic means being conceived to induce an oscillating magnetic field in a body volume of the passenger, said magnetic means being connectable to a power supply means, said data processing means being arranged to determine an amount of a power loss of said resonant circuit upon an application of said magnetic field to said body volume.

It is found to be particularly advantageous to provide the monitoring means which are suited to carry-out a substantially contact-less monitoring of a vital sign. The sensor according to the present embodiment comprises magnetic means which is arranged to induce an oscillating magnetic field in the body volume of the seated passenger upon an actuation of said sensor. The measuring principle is based on the Faraday's law. As biological tissue is a conductor, the oscillating magnetic filed induces eddy currents in the body of the passenger. The density of the induced eddy currents is proportional to the conductivity of the volume. The induced eddy currents generate a secondary magnetic field, pointing in an opposite direction with respect to a primary magnetic field. In accordance with the Faraday's law the secondary magnetic field induces an electromotive force in the primary coil, the phase of said force being 180 degrees shifted with respect to the direction of a driving current. The conductive body can thus be represented as a resistive load to the driving current. By measuring a power loss of the resonant circuit, a conclusion about the conductivity of the volume under investigation can be drawn. Because the internal impedance of the conductive body is finite, any change in load resistance due to a change in the conductivity will cause an amplitude of the measured signal to vary. When the characteristics of the primary resonant circuit are known, the conductivity of the volume under investigation can thus be determined. In a human body the conductive medium is blood. Therefore, a determination of a blood flow in a volume located in a vicinity of a resonant circuit can be used for monitoring purposes. This is particularly suitable for cardiac applications. Alternatively, it is possible to monitor a respiration rate, as during inhalation the conductivity of thorax decreases due to an air inflow.

In a further embodiment of a system according to the invention the magnetic means comprise a coil with a loop of a conductor, said loop being integrated into a shoulder portion of a set belt.

It is found to be of a particular advantage to integrate the magnetic means into the shoulder portion of the seat belt. The shoulder portion of the seat belt is defined as a loop of the seat belt, which transverses a thorax region of the passenger. Preferably, the loop of the conductor is positioned about 50 cm from a fixating means of the belt, this ensuring that the coil will be positioned substantially near a heart or a stomach of the seated passenger. Alternatively, the magnetic means can be adjustably attached to the shoulder portion of the seat belt, so that the seated passenger can customize their position with respect to his body. Preferably, the magnetic means are actuated upon a fastening of the seat belt, the belt fastening means being provided with a suitable wiring leading to a suitable battery of the vehicle.

Alternatively, the magnetic means of the system according to the invention can be integrated in a back support portion of the seat in a region, substantially corresponding to a thorax region of the seated passenger. In this case, the magnetic means can comprise a permanent wiring to a battery of the vehicle, and can be actuated upon a start-up of the vehicle's engine.

In a still further embodiment of the system according to the invention the sensor comprises an RF-transmitter unit and an RF-receiver unit, said RF-transmitter unit and said RF-receiver unit being conceived to be arranged under operating conditions in a spatial relation so that the body volume is located substantially therebetween.

This alternative embodiment enables a measurement of a blood flow in the body volume located between the RF-transmitter unit and the RF-receiver unit. The measuring principle is based on inductive coupling of two coils which varies by a conducting medium in between the coils. A change in a value of the induced voltage at the RF-receiver is a measure of the conductivity of the body volume.

A body area network according to the invention being arranged to enable a distress signaling for a seated passenger in a vehicle, comprises:
a control unit conceived to be worn by a person, said unit arranged to communicate with an ambient sensor integrated into the vehicle;
said sensor being actuatable by a power supply means, said sensor being arranged to measure a signal representative of a vital sign of the passenger;
said unit further comprising a first communication means;
said sensor further comprising a second communication means;
said unit further comprising a range detection means arranged to detect an actuated sensor in a communication range of the unit, said range detection means being arranged to actuate the first communication means in order to establish a communication with the second communication means, the second communication means being arranged to transmit said signal to the control unit upon an establishing of said communication.

A body area network (BAN) is a flexible platform comprising a control unit, which is arranged to communicate with an ambient sensor. It is also possible to arrange the BAN so that it communicates with a plurality of ambient sensors. In a preferred embodiment a person being monitored is wearing the control unit. In case the person approaches a vehicle arranged with a suitable sensor, which is set in an operating mode, the range detection means of the control unit enable a communication between the sensor and the control unit. Upon an establishing of said communication, the sensor transmits the signal representative of the vital sign of the person to the control unit, where this signal is being analyzed. Alternatively, the sensor can be provided with a pre-processing means arranged to carry-out a suitable pre-processing of a raw measured signal. This feature minimizes the data flow between modules of the BAN. Preferably, the sensor comprises magnetic means arranged as a resonant circuit, said magnetic means being conceived to induce an oscillating magnetic field in a body volume of the passenger. Such a sensor can be integrated into a shoulder portion of the vehicle's seat or in a back support portion of the seat. Alternatively, the sensor comprises an RF-transmitter unit and an RF-receiver unit, said RF-transmitter unit and said RF-receiver unit being conceived to be arranged under operating conditions in a spatial relation so that the body volume is located substantially therebetween.

In an embodiment of the body are network according to the invention, the control unit further comprises:
data processing means arranged to process the measured signal in order to yield data representative to a condition of the passenger;
analysis means arranged to analyze said data in order to yield a condition-related parameter, said analysis means being further arranged to compare said condition-related parameter to a preset valid parameter and to generate a trigger signal upon an event said health-related parameter exceeds said preset valid parameter;
indicating means actuatable by the trigger signal, said indicating means being arranged to generate a feedback to the passenger.

Preferably, the control unit comprises suitable data analysis algorithms, per se known in the art, said algorithms being arranged to calculate the condition-related parameter, like a heart-rate, a respiration rate or a blood-flow in the volume. Preferably, the control unit comprises a display to present the feedback to the passenger, said feedback comprising, for example, a textual string.

In a further embodiment of the body area network, said network being arranged to communicate to a central processing unit of the vehicle, the control unit is being further arranged to send a control signal to the central processing unit of the vehicle. Preferably, said control signal is arranged to actuate the alarming means of the vehicle, and/or to actuate the climate control means of the vehicle and/or to actuate the cruise control means of the vehicle. For this purpose the control unit comprises suitable algorithms for accommodating the settings of the vehicle in accordance with the condition of the passenger.

A vehicle according to the invention comprises the distress signaling system, said system comprising:
monitoring means arranged in said vehicle to monitor a vital sign of the seated passenger by means of a sensor arranged to measure a signal representative of said sign;
data processing means arranged to process the measured signal in order to yield data representative to a condition of said passenger;
analysis means arranged to analyze said data in order to yield a condition-related parameter, said analysis means being further arranged to compare said condition-related parameter to a preset valid parameter and to generate a trigger signal upon an event said condition-related parameter exceeds said preset valid parameter;
indicating means actuatable by the trigger signal, said indicating means being arranged to generate a feedback to said passenger.

In a preferred embodiment of the vehicle according to the invention, said vehicle comprises electronic means arranged to customize a setting of a vehicle in order to yield a preferred setting, said preferred setting being selectable from a plurality of pre-stored valid settings, said electronic means being further arranged to select a valid parameter in accordance with the selected preferred setting.

It is found particularly advantageous to personalize the functioning of the distress signaling system, for example, in case the vehicle is being operated by different persons at different times, said vehicle comprising per se known means to customize the vehicle settings, like a position of the seat, a cabin climate, etc. It is advantageous to arrange electronic means to select a valid parameter in accordance with the selected preferred setting. For example, in case a car is driven by a healthy female and a male with a cardiac condition, the valid parameters of the female differ from the valid parameters of the male. Thus, in order to enable a precise functioning of the distress system personal valid parameters are downloaded from a database for each individual and are used as reference values as long as the passenger remains seated in the vehicle.

These and other aspects of the invention will be discussed in more detail with reference to figures.

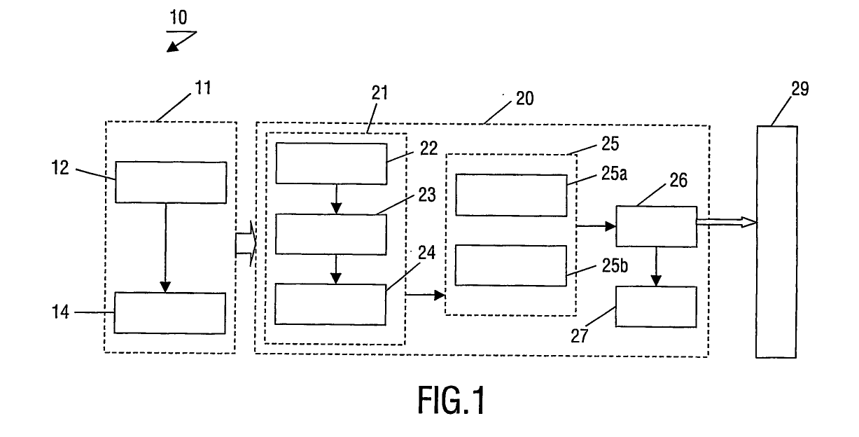

FIG. 1 presents a schematic view of an embodiment of the distress signaling system according to the invention.

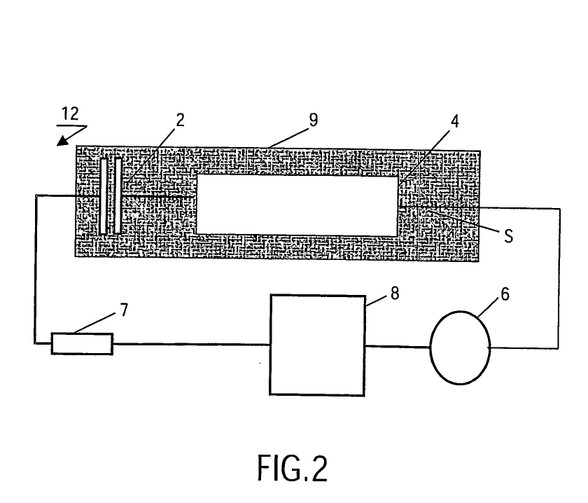

FIG. 2 present a schematic view of an embodiment of a sensor comprising magnetic means.

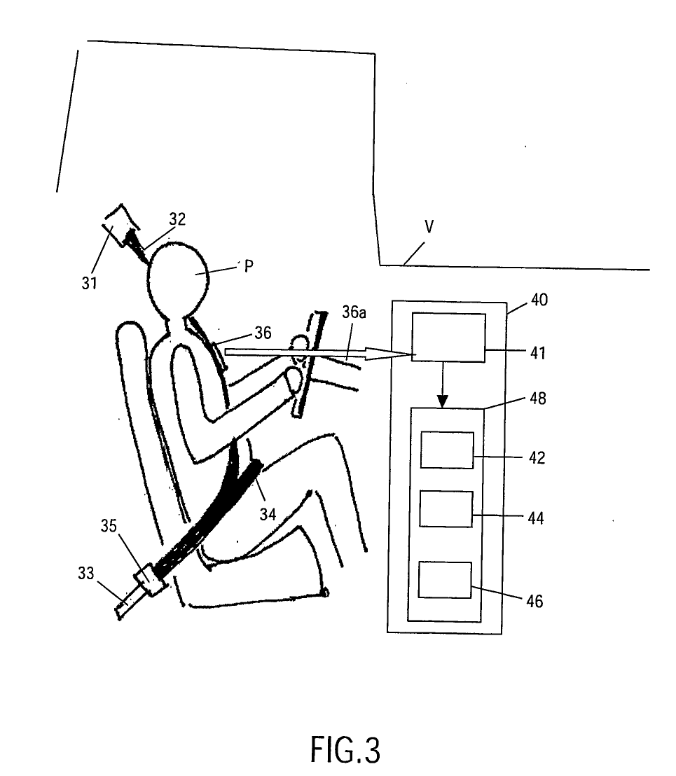

FIG. 3 presents a schematic front view of an embodiment of a sensor being integrated into a shoulder portion of a seat belt of the vehicle.

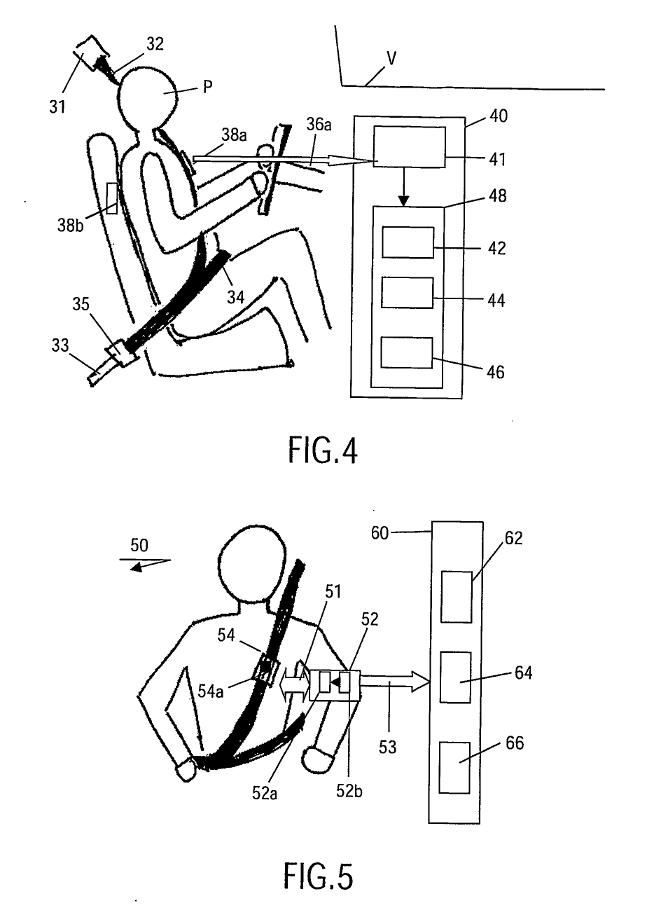

FIG. 4 presents a schematic view of a sensor comprising an RF-transmitter unit and an RF-receiver unit.

FIG. 5 presents a schematic view of an embodiment of a body are network according to the invention.

FIG. 1 presents a schematic view of an embodiment of the distress signaling system for a seated passenger according to the invention. The distress signaling system 10 comprises monitoring means 11 arranged in a vehicle in order to monitor a vital sign of the seated passenger by means of a sensor 12 arranged to measure a signal representative to said sign. The sensor 12 preferably comprise a resonant circuit (not shown) arranged in a vicinity of the body of the passenger to pick-up a signal characteristic of the targeted vital sign, for example a signal related to a blood flow. The sensor 12 can also be arranged to comprise a further magnetic means arranged as a further resonant circuit. The further magnetic means are conceived to induce an oscillating magnetic field in a further body volume of the seated passenger, for example to obtain a reference signal. Additionally, the sensor 12 can comprise a temperature meter, a blood pressure meter or any other suitable sensor. An operation of the sensor 12 will be discussed in more detail with reference to FIG. 2. Additionally, the monitoring means 11 can comprise a data pre-processing unit 14 arranged to carry-out a suitable pre-processing of the measured signal. The monitoring means 11 are preferably arranged to perform a continuous monitoring of the vital sign of the passenger and are further arranged to provide a corresponding signal, for example by means of a wire-less communication, to the front-end electronics 20 of the system 10. The front-end electronics 20 is arranged to analyze the signal from the monitoring means 11. For that purpose the front-end electronics 20 comprises a data processing means 21 arranged to process the measured signal in order to yield data representative to a condition of the passenger. The data processing means 21 comprises a preamplifier 22, an analogue processing circuit 22 and an ADC unit 23. The data processing means 21 forwards the corresponding data to the data analysis means 25, arranged to analyze said data in order to yield a condition-related parameter. For example, in case the sensor 12 is arranged to monitor a cardiac activity of the passenger, the resulting data comprises an electrocardiogram. In this case the data analysis means 25 is arranged to determine a corresponding heart-rate of the passenger. In case the sensor 12 is arranged to monitor a respiration rate of the passenger, the resulting data comprises an inhalation-exhalation curve. In this case the analysis means 25 is arranged to determine the respiration rate of the passenger. The determination of the corresponding rates can be done using a per se known computation algorithms (not shown). The thus determined condition-related parameter is written into a first look-up table 25a. The data analysis means 25 is further arranged to compare said condition-related parameter to a preset valid parameter stored in a second look-up table 25b. Preferably, the second look-up table 25b comprises a plurality of valid parameters. For example, a first valid parameter can be set to a condition of an anxiety of the passenger, a second valid parameter can be set to a condition of a minor medical abnormality and a further valid parameter can be set to a condition of a medical emergency. It is also possible that the look-up table 25b comprises a gradual conditioning of the valid parameter, given, for example by an analytical expression. In case the data analysis means detects that the condition-related parameter exceeds a preset valid parameter, it generates a trigger signal to actuate the indicating means 26. The indicating means 26 receive the trigger signal and generate a suitable feedback to the passenger. An example of a suitable feedback is a textual message of a user-interface 27. Alternatively, the user-interface can comprise a loud speaker (not shown) arranged to replay a prerecorded message or a musical tone. Additionally, the indicating means 26 can be arranged to control a vehicle control system 29, in order to alter a cabin environment, or to actuate an alarming means of the vehicle, lie a acoustic alarm and/or the emergency lights. Also, an engine of the vehicle can be controlled, for example to set the vehicle into a full stop, for example in case the driver of the vehicle is suffering from a medical emergency.

FIG. 2 presents a schematic view of an embodiment of a sensor 12 comprising magnetic means with a resonant circuit 2,4,7. The resonant circuit comprises a resistor 7 consecutively connected to a capacitance 2 and a coil 4. Power supply means 8 energise the resonant circuit 7, 2, 4 so that an oscillating magnetic field (not shown) is produced. The sensor can be arranged with its dedicated power supply means, or alternatively be energised by a battery unit of the vehicle (not shown). The signal S from the resonant circuit 7,2,4 is detected by an amperemeter 6. The power loss experienced by the resonant circuit due to an electromagnetic interaction with a conductive body (not shown) is reflected in a change in the magnitude of the signal S. By detecting the signal S the power loss by the resonant circuit is determined. In case the relation between the absolute value of the power loss and the signal S is known, the conductive characteristics of the volume being investigated can be determined. In order to ensure a constant power load, the resonant circuit preferably is enabled with a feedback loop (not shown). The feedback loop is preferably arranged so that the voltage controlling the amplitude of the resonant circuit is proportional to the RF power delivered by the resonant circuit. The resonant circuit is integrated into an insulating fabric carrier 9. Preferably, the conductors forming the coil 4 are interwoven with threads of fabric 9. In the simplest embodiment the resonant circuit comprises a single coil 4 with a single loop. In more sophisticated embodiments it is possible to design the resonator circuit with a plurality of coils comprising a plurality of loops. Preferably, the insulating fabric 9 is a part of a shoulder portion of a seat belt of the vehicle or a part of a back-support portion of the seat.

FIG. 3 presents a schematic front view of an embodiment of a sensor being integrated into a shoulder portion of a seat belt of the vehicle. The passenger P assumes a seated position and fastens the seat belt, comprising a shoulder portion 32 and a lower portion 34. The seat belt is fastened to the vehicle V by means of a fastening means 31, 33, respectively. It must be noted that a term vehicle under current definitions is applicable to a car, a train, a boat, an airplane, etc. The vehicle V is provided with a sensor 36 arranged to monitor a vital sign of the seated passenger. In a first embodiment the sensor 36 comprises magnetic means as is discussed with reference to FIG. 2 and is integrated into a shoulder portion 32 so that when the belt is fastened, the sensor will lie in a region near thorax of the passenger P. In this case a monitoring of a cardiac activity and a respiration rate of the passenger can be enabled. The sensor 36 can be powered by a battery unit (not shown) of the vehicle, corresponding wiring being integrated into the shoulder portion of the seat belt, an electrical connection thereto 35 being integrated into the belt fastening means 33. Preferably, the powering of the sensor 36 is actuated upon a fastening of the belt fastening means 33. The sensor 36 provides a signal representative to the vital sign of the passenger to the data processing means (not shown), which is preferably integrated into a dashboard 40 of the vehicle V. Preferably, a communication between the sensor 36 and the data processing means is enabled by means of a wire-less signaling, indicated by an arrow 36a. Upon an event a trigger signal (not shown) to the indicating means is actuated, the indicating means 41 generate a suitable feedback to the passenger P. Preferably, the indicating means send a control signal to a central processing unit 48 of the vehicle, said control signal being arranged to control an alarming means 42 of the vehicle, an engine of the vehicle 44 and a climate control means 46 of the vehicle.

FIG. 4 presents a schematic view of a sensor comprising an RF-transmitter unit and an RF-receiver unit. The RF-transmitter unit 38b is preferably integrated into a back support portion of a seat of the vehicle V. The RF-receiver unit 38a is preferably integrated into a shoulder portion 32 of the seat belt of the seat of the vehicle V. The RF-transmitter unit is arranged to transmit a suitable RF-power to transverse a thorax region of the seated passenger. The measurement principle is as follows. The RF-transmitter unit comprises a first magnetic coil and the RF-receiver unit comprises a second magnetic coil, which are inductively coupled. An oscillating magnetic field which is generated by the first magnetic coil induces a voltage in the second magnetic coil. The induced voltage in the second magnetic coil varies in time if the conductivity of a medium between the first magnetic coil and the second magnetic coil (thorax, heart) Therefore, time variations of the conductivity in a body volume which can be caused e.g. by a heart activity and/or respiration influence the induced voltage in the second coil.

Based on that principle a variation of a received signal by the RF-receiver unit provides information on a cardiac and/or pulmonary activity of the seated passenger P. The RF-transmitter unit 38b is preferably provided with a stationary wiring to a battery unit (not shown) of the vehicle V. The RF-receiver unit 38a is preferably energized by the battery unit of the vehicle V upon a fastening of the belt fastening means 33, a corresponding electrical wiring 35 being integrated into the belt fastening means 33. The functioning of other units, shown in the FIG. 4 is substantially the same to the functioning of the corresponding units, as is discussed with reference to FIG. 3.

FIG. 5 presents a schematic view of an embodiment of a body area network according to the invention. The body area network 50 comprises a control unit 52 conceived to be worn by a person, said unit being arranged to communicate with an ambient sensor 54. Preferably, said communication is enabled by means of a wireless communication, schematically illustrated by an arrow 51. The sensor 54 is arranged in a vehicle (not shown) and is conceived to measure a signal representative to a vital sign of the person. The control unit 52 comprises a first communication means 52a, for example a suitable first RF-transmitter/receiver unit, the sensor 54 comprises a second communication means 54a, for example a suitable second RF-transmitter/receiver unit. The control unit further comprises a range detection means 52b, arranged to detect the sensor 54 in a communication range of the first RF-transmitter/receiver unit. In case the range detection means 54b detect the sensor 54 in said range, the range detection means 54 actuate the first communication means 52a in order to establish a communication to the second communication means 54a. Upon an establishing of said communication, the second transmitting unit transmits the measured signal to the control unit 52. The control unit 52 further comprises data processing means (not shown) arranged to process the measured signal in order to yield data representative to a condition of the passenger; analysis means (not shown) arranged to analyze said data in order to yield a condition-related parameter, said analysis means being further arranged to compare said condition-related parameter to a preset valid parameter and to generate a trigger signal upon an event said health-related parameter exceeds said preset valid parameter. Data processing means and data analysis means are per se known in the art and the functioning thereof will not be explained in detail here. The control unit 52 further comprises indicating means (not shown) actuatable by the trigger signal, said indicating means being arranged to generate a feedback to the passenger. Preferably, the indicating means comprise a display arranged to feedback a textual message. Additionally, the control unit 52 can comprise an audio feedback means, for example a loud speaker arranged to feedback an acoustic signal to the person.

The control unit 52 is preferably arranged to send a control signal 53 to a vehicle control means 60. Preferably, said control signal is arranged to actuate a vehicle alarming means 62, and/or a cruise control means 64 and/or a vehicle climate control means 66 in order to minimize a potential harm to the passenger as a result of his condition.

1. Anordnung A distress signaling system (10) for a seated passenger (P) in a vehicle (V), said system comprising:
monitoring means (11) arranged in said vehicle to monitor a vital sign of the seated passenger by means of a sensor (12) arranged to measure a signal (S) representative of said sign;
analysis means (25) arranged to analyze said signal (S) in order to yield a condition-related parameter (25a), said analysis means being further arranged to derive from said condition-related parameter a trigger signal by comparison with a preset valid parameter.

2. A system according to claim 1 comprising indicating means (26) actuatable by the trigger signal, said indicating means being arranged to generate a feedback to said passenger.

3. A system according to claim 1, wherein the sensor (12) comprises:
a resonant circuit, said circuit being conceived to induce an oscillating magnetic field in a body volume of the passenger; and
data processing means being arranged to determine an amount of a power loss of said resonant circuit upon interaction of said magnetic field with said body volume.

4. A system according to claim 3, werhein the magnetic means comprises a coil (4) with a loop of a conductor, said loop being integrated into a shoulder portion of a seatbelt (34) of the vehicle.

5. A system according to claim 3, wherein the magnetic means comprises a coil (4) with a loop of a conductor, said loop being integrated into a back support portion of a seat of the vehicle.

6. A system according to claim 3, wherein the sensor comprises an RF-transmitter (38b) unit and an RF-receiver unit (38a), said RF-transmitter unit and said RF-receiver unit being conceived to be arranged under operating conditions in a spatial relation so that the body volume is located substantially therebetween.

7. A system according to claim 2, wherein the indicating means (26) comprises a loudspeaker arranged to generate an audio feedback to the person.

8. A system according to claim 7, wherein the indicating means (26) is further arranged to control a climate control means of the vehicle upon a receipt of a trigger signal.

9. A system according to claim 2, wherein the indicating means (26) is further arranged to actuate an alarming means (42) of the vehicle upon a receipt of the trigger signal.

10. A system according to claim 9, wherein the indicating means (26) is further arranged to control an engine (44) of the vehicle upon a receipt of the trigger signal.

11. A body area network (50) arranged to enable a distress signaling for a seated passenger in a vehicle, said body area network comprising:
a control unit (52) conceived to be worn by the passenger, said unit arranged to communicate with an ambient sensor (54) integrated into the vehicle;
said sensor being arranged to measure a signal representative of a vital sign of the passenger;
said unit further comprising a first communication means (52a);
said sensor further comprising a second communication means (54a);
said unit further comprising a range detection means (52b) arranged to detect an actuated sensor (54) in a communication range of the unit;
said range detection means (52b) being arranged to actuate the first communication means (52a) in order to establish a communication with the second communication means (54a), the second communication means being arranged to transmit said signal (51) to the control unit upon an establishing of said communication.

12. A body area network according to claim 11, wherein the sensor (54) comprises a resonant circuit being conceived to induce an oscillating magnetic field in a body volume of the passenger.

13. A body area network, according to claim 12, wherein the sensor comprises an RF-transmitter unit and an RF-receiver unit, said RF-transmitter unit and said RF-receiver unit being conceived to be arranged under operating conditions in a spatial relation so that the body volume is located substantially therebetween.

14. A body area network according to claim 12, wherein the control unit further comprises analysis means arranged to analyze said signal in order to yield a condition-related parameter, said analysis means being further arranged to derive from said condition-related parameter a trigger signal comparison with a preset valid parameter.

15. A network according to claim 14, comprising indicating means actuatable by the trigger signal, said indicating means being arranged to generate a feedback to the passenger.

16. A body area network according to claim 11, wherein said vehicle comprises a central processing unit (29,60), said control unit being further arranged to send a control signal (53 to the central processing unit of the vehicle (29,60).

17. A body area network according to claim 16, wherein the control signal (53) is arranged to actuate an alarming means (62) or a motor control means of the vehicle.

18. A body area network unit according to claim 16, wherein the control signal (53) is aranged to actuate a climate control means (66) of the vehicle.

19. A method of signaling a condition of distress of a seated passenger in a vehicle, said method comprising the steps of:
monitoring a vital sign of the seated passenger in said vehicle by means of a sensor integrated in said vehicle, said sensor being arranged to measure a signal representative of said sign;
analyzing said signal in order to yield a condition-related parameter;
comparing said condition-related parameter to a preset valid parameter;
generating a feedback to said passenger upon an event said condition-related parameter deviates from the preset valid parameter with a preset amount.

20. A method according to claim 19, said method further comprising the step of actuating an alarming means of the vehicle.

21. A method according to claim 19, said method further comprising the step of controlling an engine of the vehicle.

22. A vehicle comprising a distress signaling system according to claim 1.

23. A vehicle according to claim 22, wherein said vehicle comprises electronic means arranged to customize a setting of a vehicle in order to yield a preferred setting, said preferred setting being selectable from a plurality of pre-stored valid settings, said electronic means being further arranged to select a valid parameter in accordance with the selected preferred setting.
